(19) United States
(12) Patent Application Publication
(10) Pub. No.: US 2026/0148579 A1
(43) Pub. Date: May 28, 2026

(54) IMAGE READING APPARATUS THAT DIVIDES IMAGE DATA AT POSITION OF PAGE INCLUDING CODE

(71) Applicant: KYOCERA Document Solutions Inc., Osaka (JP)

(72) Inventors: Louella VILLAMORA, Osaka (JP); Shanice YAP, Osaka (JP); Dannovan Paul DEVIS, Osaka (JP); Celine Louise OLAN, Osaka (JP); Rogelio MAHUSAY, JR., Osaka (JP)

(73) Assignee: KYOCERA Document Solutions Inc., Osaka (JP)

(21) Appl. No.: 19/393,993

(22) Filed: Nov. 19, 2025

(30) Foreign Application Priority Data
Nov. 27, 2024 (JP) 2024-206770

(51) Int. Cl. G06V 30/414; G06V 30/142; G06V 30/148

(52) U.S. Cl. CPC G06V 30/414; G06V 30/1426; G06V 30/153

(57) ABSTRACT

An image reading apparatus includes an image reading device, an operation device, and a controller. The controller executes, when a code is detected from image data representing a document image of a plurality of pages, and a normal partitioning instruction is received via the operation device, a normal partitioning process including partitioning the image data at a position corresponding to a page containing the code, the document image of the page containing the code inclusive, and executes, when the code is detected from the image data, and an exclusion partitioning instruction is received via the operation device, an exclusion partitioning process including partitioning the image data at the position corresponding to the page containing the code, excluding the document image of the page containing the code.

### INCORPORATION BY REFERENCE

This application claims priority to Japanese Patent Application No. 2024-206770 filed on Nov. 27, 2024, the entire contents of which are incorporated by reference herein.

### BACKGROUND

The present disclosure relates to an image reading apparatus, and in particular to a technique to execute a predetermined process, using a code detected from image data.

Various techniques are known that include detecting a code such as a quick response (QR) code (registered trademark) from image data representing a document image, and executing a predetermined process using the detected code.

For example, a first technique is known that includes generating character data of related information contained in two-dimensional code detected from the image data, and generating a document file by embedding the generated character data at the position of the two-dimensional code in the image data.

A second known technique includes displaying a screen for making a user select a desired code, on a display device, when a plurality of codes are detected from a scanned image, and executing a process utilizing the selected code.

Further, a third known technique includes sorting a plurality of documents according to a sorting method contained in the two-dimensional code, detected from the image data representing the plurality of documents, some pages of which include the two-dimensional code.

### SUMMARY

The disclosure proposes further improvement of the foregoing techniques.

In an aspect, the disclosure provides an image reading apparatus including an image reading device, an operation device, and a controller. The image reading device reads each page of a plurality of documents, and generates image data representing a document image of a plurality of pages. To the operation device, an instruction of a user is inputted. The controller includes a processor, and executes a code detection process for detecting a predetermined code, with respect to the image data, when the processor executes a control program. The controller executes, when the code is detected through the code detection process, and a normal partitioning instruction is received via the operation device, a normal partitioning process including partitioning the image data at a position corresponding to a page containing the code, the document image of the page containing the code inclusive; executes, when the code is detected through the code detection process, and an exclusion partitioning instruction is received via the operation device, an exclusion partitioning process including partitioning the image data at the position corresponding to the page containing the code, excluding the document image of the page containing the code; and converts new image data generated through the normal partitioning process or the exclusion partitioning process, to an image file of a predetermined format.

### BRIEF DESCRIPTION OF THE DRAWINGS

FIG. 1 is a front cross-sectional view showing a structure of an image forming apparatus;

FIG. 2 is a block diagram showing an internal configuration of the image forming apparatus;

FIG. 3 is a schematic drawing showing an example of a job selection screen;

FIG. 4 is a schematic drawing showing an example of a transmission destination selection screen;

FIG. 5 is a schematic drawing showing an example of a transmission destination setting screen;

FIG. 6 is a schematic drawing showing an example of a code setting screen;

FIG. 7A is a schematic drawing showing an example of a detection region setting screen;

FIG. 7B is a schematic drawing showing another example of the detection region setting screen;

FIG. 8A is a schematic drawing showing an example of a transmission file setting screen;

FIG. 8B is a schematic drawing showing another example of the transmission file setting screen;

FIG. 9 is a schematic drawing showing an example of a file name setting screen;

FIG. 10A is a flowchart showing a file transmission process;

FIG. 10B is a flowchart showing the file transmission process;

FIG. 11 is a schematic drawing showing an example of image data representing document images of a plurality of pages;

FIG. 12 is a schematic drawing for explaining a normal partitioning process;

FIG. 13 is a schematic drawing for explaining an exclusion partitioning process;

FIG. 14A is a schematic drawing showing an example of the case where a code is unable to be detected;

FIG. 14B is a schematic drawing showing another example of the case where the code is unable to be detected; and

FIG. 15 is a schematic drawing showing an example of a resetting screen.

### DETAILED DESCRIPTION

Hereafter, an image forming apparatus, including an image reading apparatus according to an embodiment of the disclosure, will be described, with reference to the drawings.

### Configuration of Image Forming Apparatus 1

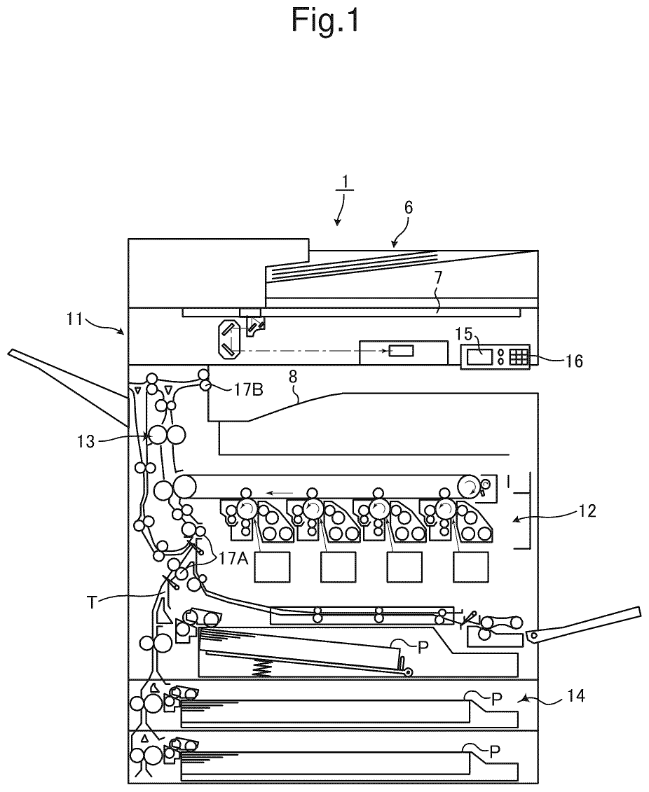

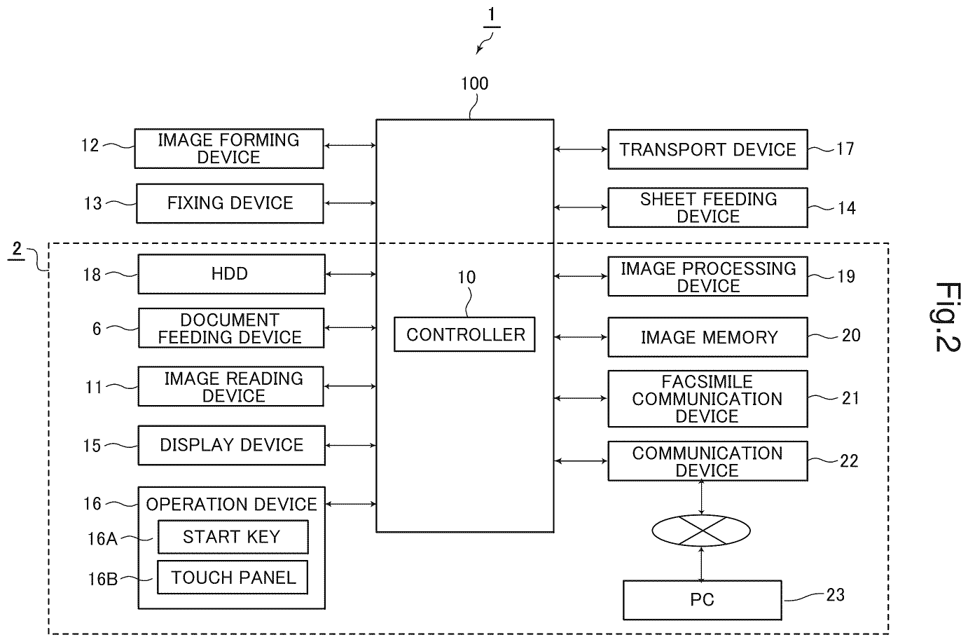

FIG. 1 is a front cross-sectional view showing a structure of the image forming apparatus 1. FIG. 2 is a block diagram showing an internal configuration of the image forming apparatus 1. Referring to FIG. 1 and FIG. 2, the image forming apparatus 1 is a multifunction peripheral having a plurality of functions, such as copying, transmitting, printing, and facsimile transmission.

The image forming apparatus 1 includes a document feeding device 6, an image reading device 11, an image forming device 12, a fixing device 13, a sheet feeding device 14, a display device 15, an operation device 16, and a transport device 17.

The document feeding device 6 delivers documents placed on a document tray one by one to a reading position of the image reading device 11. The document feeding device 6 is configured to open and close a platen glass 7, by being made to pivot up and downward about a shaft located on the deeper side in FIG. 1. The document feeding device 6 also serves as a document retention cover that presses the document on the platen glass 7 from the upper side.

The image reading device 11 includes a scanner that optically reads the document, and generates the image data representing the document image. The image reading device 11 reads the document delivered from the document feeding device 6, or the document placed on the platen glass 7.

The image forming device 12 includes a photoconductor drum, a charging device, an exposure device, a developing device, and a primary transfer device. The image forming device 12 forms a toner image on a sheet P transported along a transport route T by the transport device 17, on the basis of the image data generated by the image reading device 11, or image data inputted via the communication device 22.

The fixing device 13 heats and presses the sheet P on which the toner image has been formed, to thereby fix the toner image onto the sheet P. The sheet P on which the image has been formed by fixing the toner image is delivered to an output tray 8.

The sheet feeding device 14 includes a manual bypass tray and a plurality of sheet cassettes. The sheet feeding device 14 draws out the sheets P stored in one of the plurality of sheet cassettes, or set on the manual bypass tray one by one with a pickup roller, and delivers the sheet P to the transport route T. Here, the sheet P is not limited to a paper medium but may be, for example, an overhead projector (OHP) sheet.

The display device 15 includes a liquid crystal display or an organic light-emitting diode display, and displays various types of screen.

The operation device 16 includes a plurality of hard keys such as a start key 16A, for inputting instructions to execute a copying operation or a scanning operation. The operation device 16 also includes a touch panel 16B overlaid on the display device 15. To the operation device 16, the instruction from the user is inputted.

The transport device 17 includes transport roller pairs 17A, a delivery roller pair 17B, and a transport motor. When the transport roller pair 17A and the delivery roller pair 17B are driven to rotate by the transport motor, the sheet P delivered from the sheet feeding device 14 is transported along the transport route T.

Referring to FIG. 2, the image forming apparatus 1 further includes a control device 100, a hard disk drive (HDD) 18, an image processing device 19, an image memory 20, a facsimile communication device 21, and a communication device 22.

The control device 100 includes a processor, a random-access memory (RAM), and a read-only memory (ROM). The processor is, for example, a central processing unit (CPU), a micro processing unit (MPU), or an application specific integrated circuit (ASIC).

The control device 100 acts as a controller 10, when the processor executes a control program stored in the ROM or the HDD 18. The controller 10 controls the operation of the components of the image forming apparatus 1. Here, the controller 10 may be constituted in the form of a logic circuit, instead of being realized by the operation based on the control program.

The control device 100 is electrically connected to the document feeding device 6, the image reading device 11, the image forming device 12, the fixing device 13, the sheet feeding device 14, the display device 15, the operation device 16, the transport device 17, the HDD 18, the image processing device 19, the image memory 20, the facsimile communication device 21, and the communication device 22.

In this embodiment, the control device 100, the document feeding device 6, the image reading device 11, the display device 15, the operation device 16, the HDD 18, the image processing device 19, the image memory 20, the facsimile communication device 21, and the communication device 22 act as an image reading apparatus 2.

The HDD 18 is a large-capacity storage medium for storing various types of data. In the HDD 18, various control programs for realizing the functions of the image forming apparatus 1 are stored. The HDD 18 contains, as examples of the various control programs, a transmission program for executing a file transmission process to be subsequently described, and an analysis program for executing a basic code analysis process including analyzing a code detected from the image data and acquiring information contained in the code.

The image processing device 19 executes image processing, as necessary, with respect to the image data generated by the image reading device 11. In the image memory 20, the image data generated by the image reading device 11 is temporarily stored. The facsimile communication device 21 transmits and receives the image data, through the public telephone network.

The communication device 22 includes a communication module such as a local area network (LAN) board. The controller 10 performs data communication via the communication device 22, with an external device such as a personal computer (PC) 23 connected via a network.

A power source is connected to each of the components of the image forming apparatus 1. When the user turns the power on, the power is supplied from the power source, to each of the components of the image forming apparatus 1.

### Operation

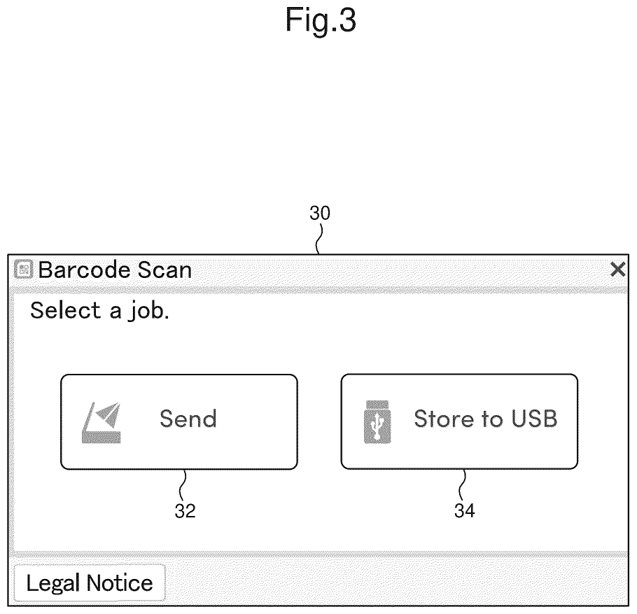

Referring to FIG. 3 to FIG. 13, an operation of the image forming apparatus 1, performed when executing the file transmission process, will be described hereunder.

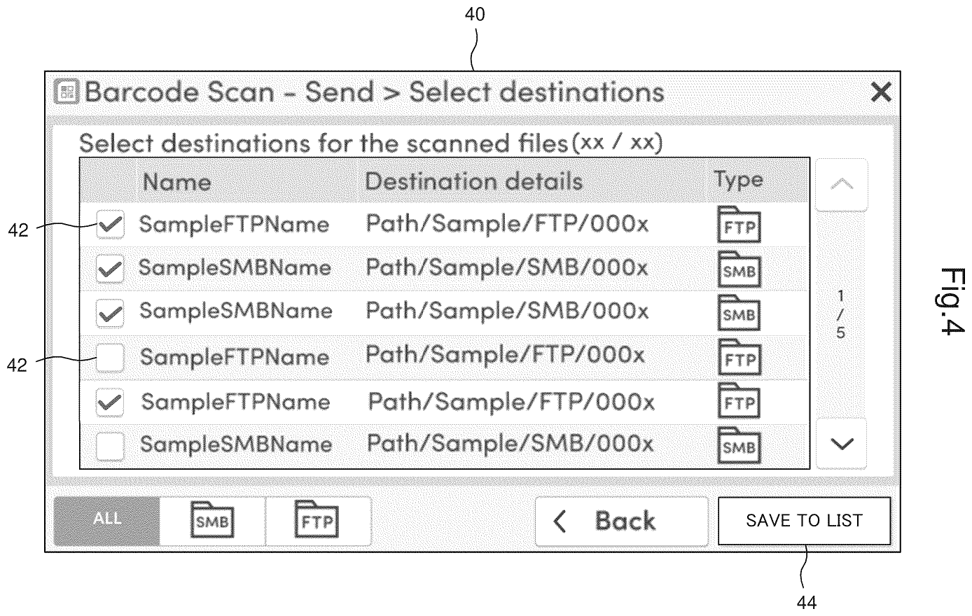

Upon receipt of an instruction to perform a code scanning function via the operation device 16, the controller 10 causes the display device 15 to display a job selection screen 30 shown in FIG. 3. When the touch panel 16B detects a touch operation of the user on a key 32 in the job selection screen 30, the controller 10 receives an instruction to execute a transmission job, and causes the display device 15 to display a transmission destination selection screen 40 shown in FIG. 4.

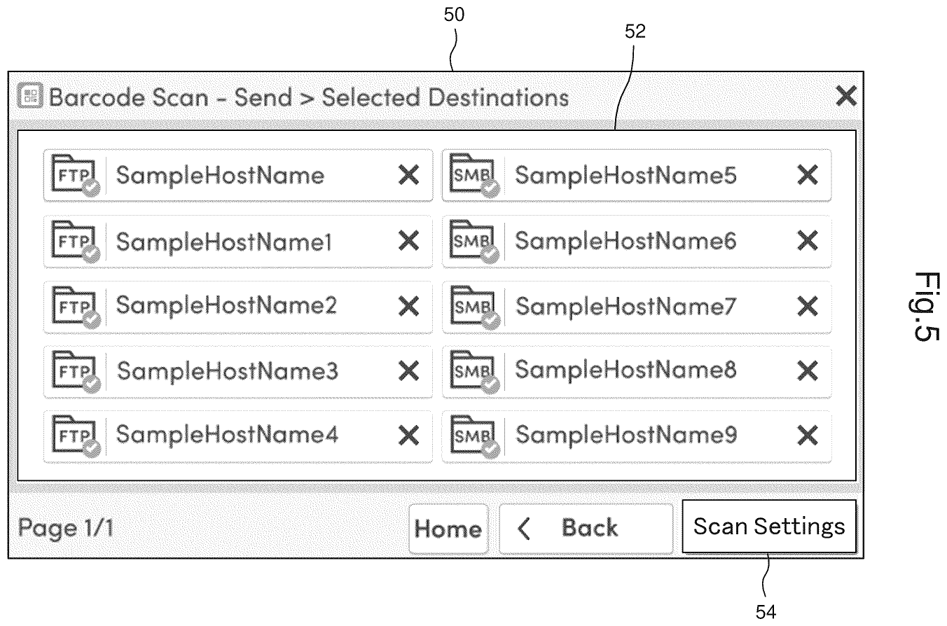

When the touch panel 16B detects the touch operation of the user on at least one of a plurality of checkboxes 42 respectively corresponding to a plurality of transmission destinations, the controller 10 causes the display device 15 to display a check mark in the touched checkbox 42. When the touch panel 16B detects the touch operation of the user on a key 44, with the check mark displayed in at least one of the plurality of checkboxes 42, the controller 10 causes the display device 15 to display a transmission destination setting screen 50 shown in FIG. 5.

The transmission destination setting screen 50 displayed on the display device 15 includes a list 52, showing all the transmission destinations selected on the transmission destination selection screen 40. When the touch panel 16B detects the touch operation of the user on a key 54, under such a situation, the controller 10 determines all the transmission destinations included in the list 52, as the destination of the transmission job. In this embodiment, 10 destinations can be selected at maximum, for each of the transmission jobs.

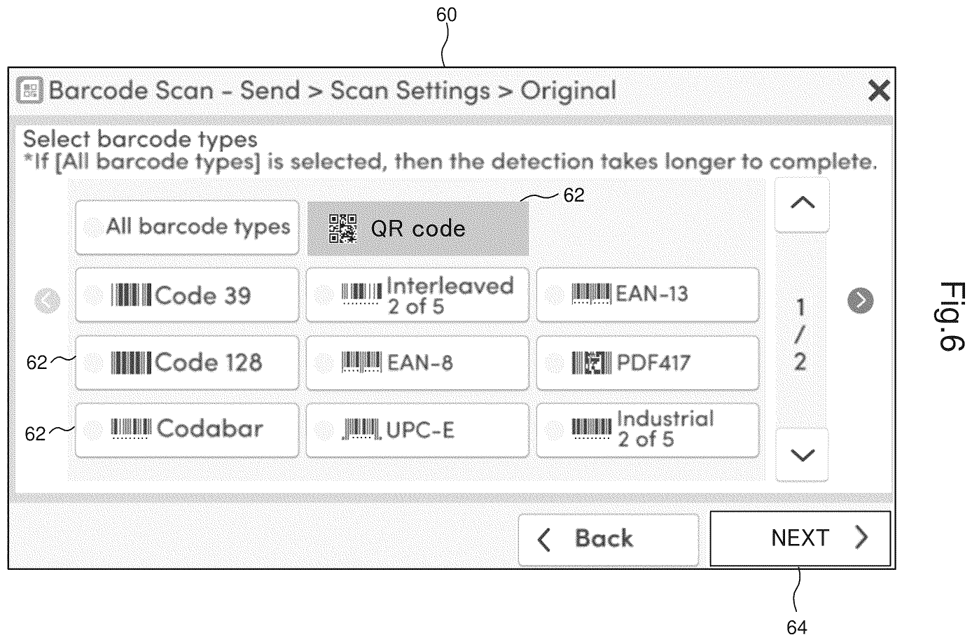

Upon determining the destinations of the transmission job as above, the controller 10 causes the display device 15 to display a code setting screen 60 shown in FIG. 6. When the touch panel 16B detects the touch operation of the user on at least one of a plurality of keys 62 for selecting the type of the code to be detected, the controller 10 causes the display device 15 to display the touched key 62 in a different color from the other keys 62.

The plurality of keys 62 respectively correspond, for example, to Aztec, Codabar, Code 39, Code 93, Code 128, Data Matrix, EAN-8, EAN-13, IATA 2 of 5, Industrial 2 of 5, Interleaved 2 of 5, Matrix 2 of 5, MaxiCode, Patch, PDF417, Postnet, QR code, UCC-128, UPC-A, and UPC-E.

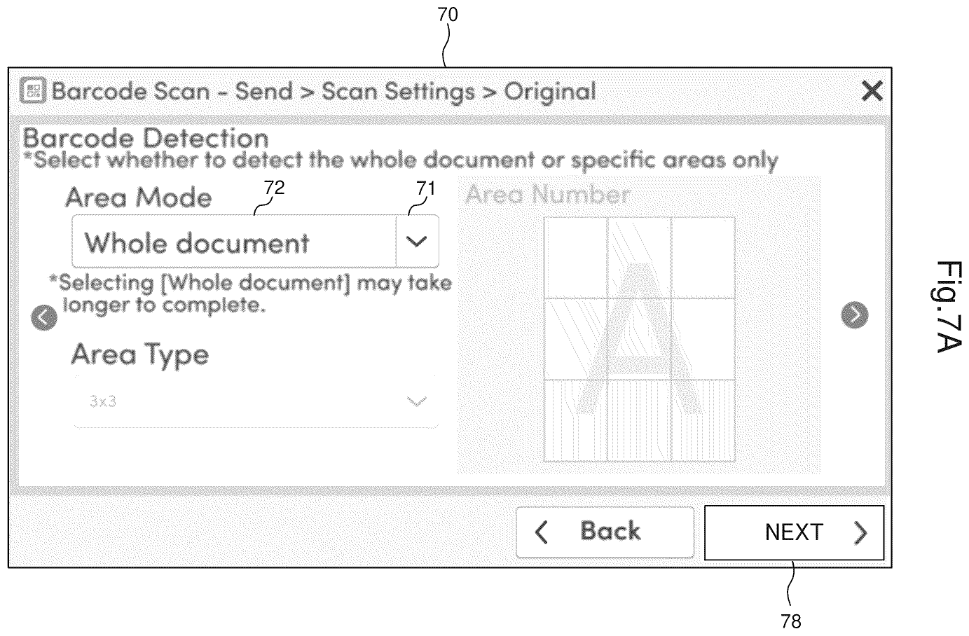

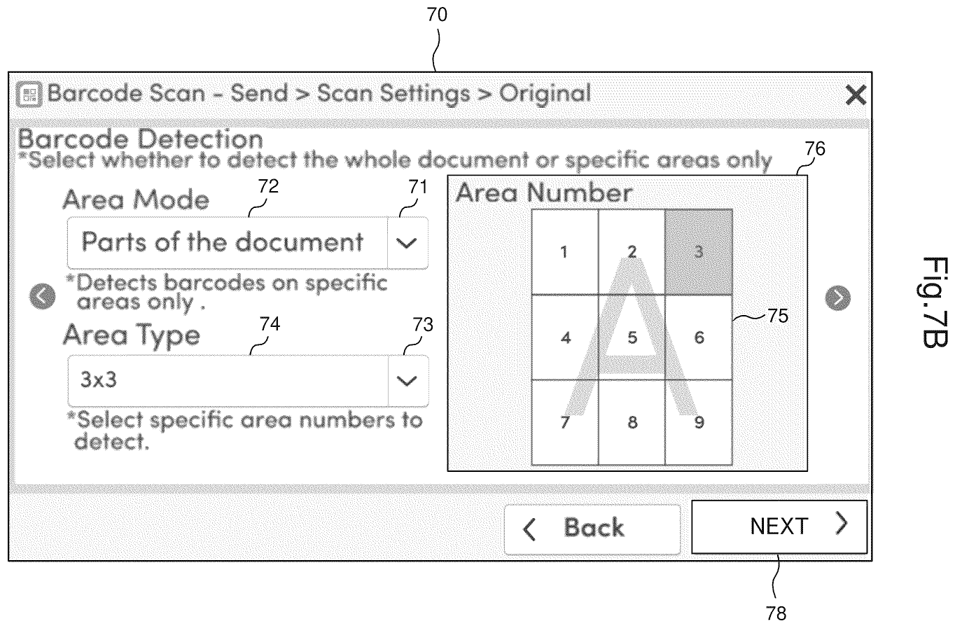

When the touch panel 16B detects the touch operation of the user on a key 64, with at least one of the plurality of keys 62 being displayed in the different color, the controller 10 determines the type of the code corresponding to the key 62 displayed in the different color, as the code to be detected. Upon determining the type of the code to be detected as above, the controller 10 causes the display device 15 to display a detection region setting screen 70, shown in FIG. 7A and FIG. 7B.

When the touch panel 16B detects the touch operation of the user on a button 71 in the detection region setting screen 70, the controller 10 causes the display device 15 to display a pulldown list, for selecting one of the entirety and a part, in relation to the setting of the detection region in the document image, in the proximity of the button 71.

When the touch panel 16B detects the touch operation of the user on the selection region indicating the entirety in the pulldown list, the controller 10 causes the display device 15 to display a character string “Whole document” in a box 72, as shown in FIG. 7A. When the touch panel 16B detects the touch operation of the user on a key 78, under such a situation, the controller 10 receives the instruction to set the detection region, and sets the entirety of the document image as the detection region.

In contrast, when the touch panel 16B detects the touch operation of the user on the selection region indicating a part in the pulldown list, the controller 10 causes the display device 15 to display a character string “Parts of the document” in the box 72, as shown in FIG. 7B. At this time, the controller 10 causes the display device 15 to operably display a button 73 for setting the size of the detection region.

When the touch panel 16B detects the touch operation of the user on the button 73, the controller 10 causes the display device 15 to display a pulldown list, for selecting one of division into 9 parts and division into 16 parts, in relation to the setting of the size of the detection region, in the proximity of the button 73.

For example, when the touch panel 16B detects the touch operation of the user on the selection region indicating the division into 9 parts in the pulldown list, the controller 10 causes the display device 15 to display a character string “3×3 (3 columns by 3 rows)” in a box 74, and also an image 75, including region numbers from 1 to 9 arranged in the pattern of 3 columns by 3 rows, from the upper left corner to the lower right corner, in a display region 76, as shown in FIG. 7B.

When the touch panel 16B detects the touch operation of the user on one of the regions in the image 75, the controller 10 causes the display device 15 to display the touched region in a different color from the remaining regions. When the touch panel 16B detects the touch operation of the user on the key 78 under such a situation, the controller 10 receives an instruction to set the detection region, and sets the selected region (more specifically, information indicating the size of the detection region and the region number), as the detection region.

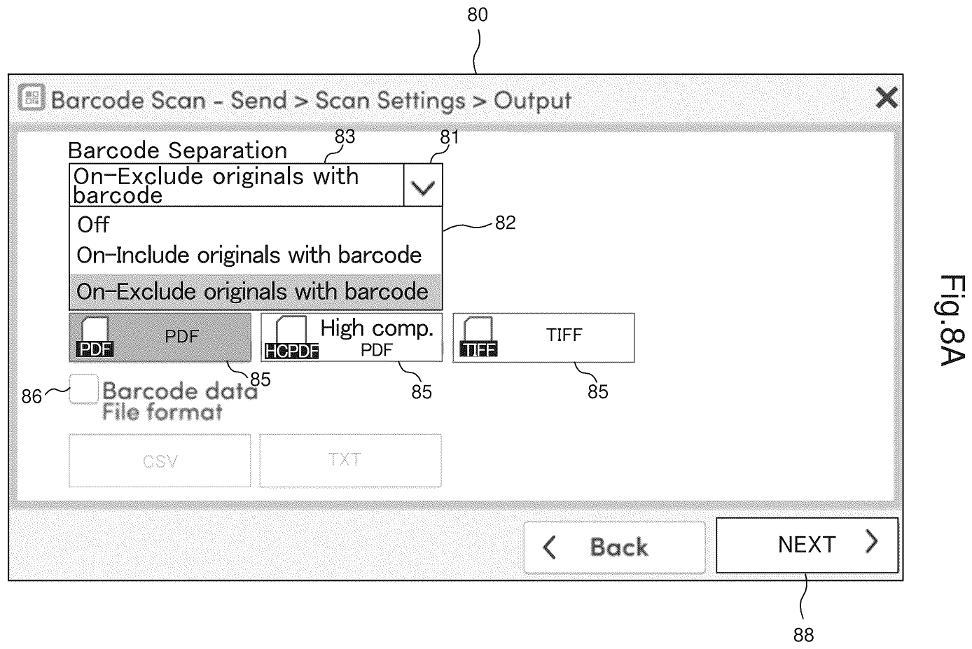

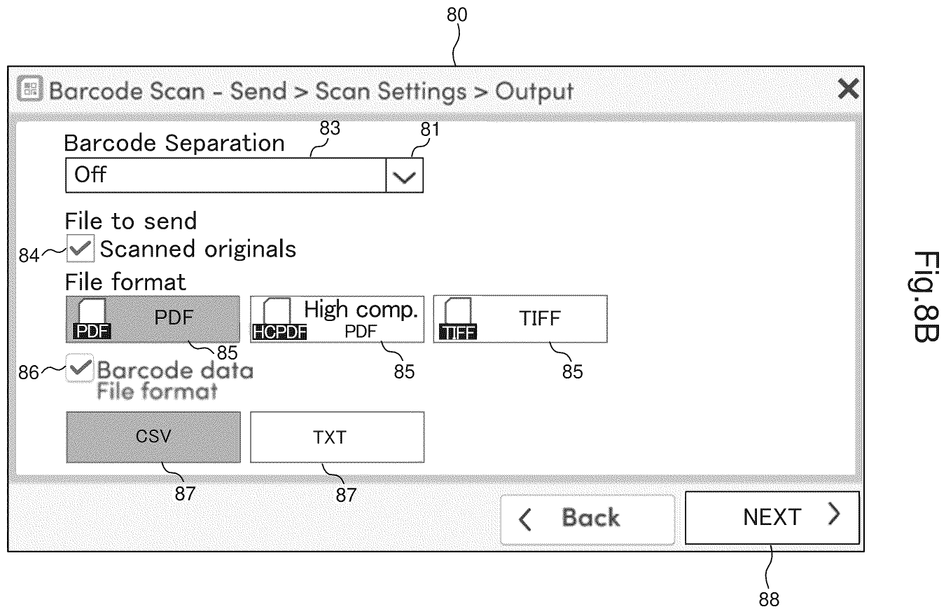

Upon setting the detection region as above, the controller 10 causes the display device 15 to display a transmission file setting screen 80 shown in FIG. 8A and FIG. 8B. When the touch panel 16B detects the touch operation of the user on the button 81 in the transmission file setting screen 80, the controller 10 causes the display device 15 to display a pulldown list 82 for selecting one of non-partitioning, normal partitioning, and exclusion partitioning, as partitioning mode of the image data, in the proximity of the button 81.

Here, the non-partitioning refers to a mode that the image data is not partitioned. The normal partitioning refers to partitioning the image data at the position corresponding to the page containing the code, the page containing the code inclusive. The exclusion partitioning refers to partitioning the image data at the position corresponding to the page containing the code, excluding the page containing the code.

When the touch panel 16B detects the touch operation of the user on the selection region corresponding to the exclusion partitioning in the pulldown list 82, the controller 10 causes the display device 15 to display a character string “On-Exclude originals with barcode” in a box 83, as shown in FIG. 8A.

When the touch panel 16B detects the touch operation of the user on the selection region corresponding to the normal partitioning in the pulldown list 82, the controller 10 causes the display device 15 to display a character string “On-Include originals with barcode” in the box 83.

When the touch panel 16B detects the touch operation of the user on the selection region corresponding to the non-partitioning in the pulldown list 82, the controller 10 causes the display device 15 to display a character string “Off” in the box 83, as shown in FIG. 8B.

When the non-partitioning is selected, the controller 10 causes the display device 15 to operably display a checkbox 84, for selecting whether to transmit the image file. When the touch panel 16B detects the touch operation of the user on the checkbox 84, the controller 10 causes the display device 15 to display a check mark in the checkbox 84.

When the touch panel 16B detects the touch operation of the user on one of a plurality of keys 85 for selecting a file format of the image file, the controller 10 causes the display device 15 to display the detected key 85 in a different color from the remaining keys 85. The plurality of keys 85 respectively correspond, for example, to portable document format (PDF), high-compression PDF, and tagged image file format (TIFF).

When the touch panel 16B detects the touch operation of the user on a checkbox 86 for selecting whether to transmit the code data, the controller 10 causes the display device 15 to display a check mark in the checkbox 86, as shown in FIG. 8B. At the same time, the controller 10 causes the display device 15 to operably display a plurality of key 87, for selecting the file format of the text file indicating the code data.

When the touch panel 16B detects the touch operation of the user on one of a plurality of keys 87, the controller 10 causes the display device 15 to display the touched key 87 in a different color from the remaining keys 87. The plurality of keys 87 respectively correspond, for example, to comma-separated value (CSV) format, and TXT format.

When the touch panel 16B detects the touch operation of the user on a key 88, under such a situation, the controller 10 sets the partitioning mode of the image data to one of non-partitioning, normal partitioning, and exclusion partitioning, according to the box 83. When the check mark is displayed in the checkbox 84, the controller 10 sets the transmission of the image file to “necessary”, and to “unnecessary” when the check mark is not displayed in the checkbox 84.

The controller 10 sets the file format of the image file, to the file format corresponding to the key 85 displayed in the different color. When the check mark is displayed in the checkbox 86, the controller 10 sets the transmission of the code data to “necessary”, and to “unnecessary” when the check mark is not displayed in the checkbox 86. The controller 10 sets the file format of the text file, to the file format corresponding to the key 87 displayed in the different color.

Here, when the non-partitioning is selected as the partitioning mode of the image data, the controller 10 sets at least one of the transmission of the image file and the transmission of the code data, to “necessary”. In other words, in this embodiment it is not assumed that, when the non-partitioning is selected as the partitioning mode of the image data, both of the transmission of the image file and the transmission of the code data are set to “unnecessary”.

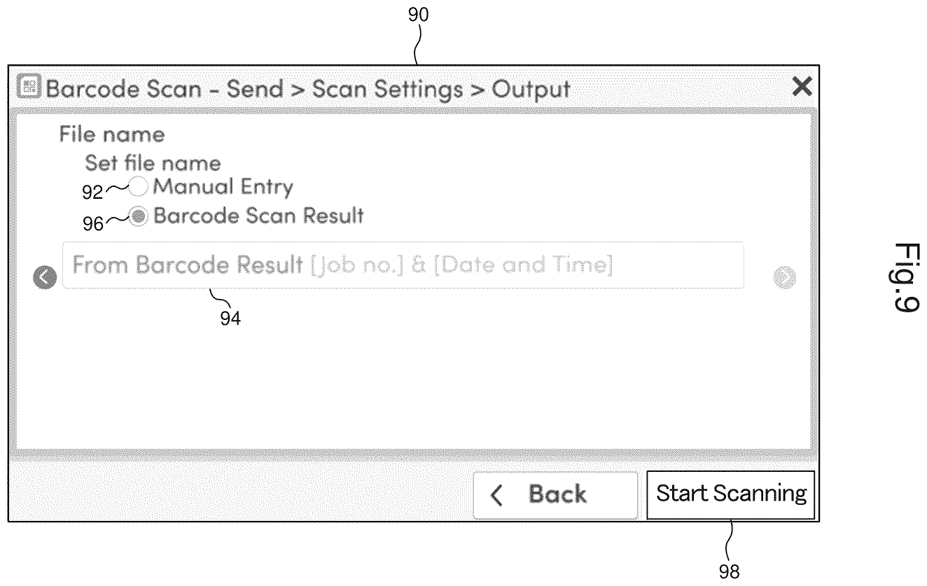

When the settings related to the transmission file are determined, the controller 10 causes the display device 15 to operably display a file name setting screen 90 shown in FIG. 9. When the touch panel 16B detects the touch operation of the user on a checkbox 92 for selecting manual input of the file name, the controller 10 causes the display device 15 to display a check mark in the checkbox 92.

At this time, the controller 10 causes the display device 15 to operably display a box 94 for inputting the file name. When the touch panel 16B detects, for example, an inputting operation of the user on a software keyboard, the controller 10 causes the display device 15 to display a character or a character string that has been inputted, in the box 94. When the touch panel 16B detects the touch operation of the user on a key 98, under such a situation, the controller 10 sets the “manual input” as the setting of the file name, and stores the inputted character or character string, for example in the RAM.

When the touch panel 16B detects the touch operation of the user on a checkbox 96 for selecting automatic generation of the file name, the controller 10 causes the display device 15 to display a check mark in the checkbox 96. When the touch panel 16B detects the touch operation of the user on a key 98, under such a situation, the controller 10 sets the “automatic generation” as the setting of the file name.

### File Transmission Process

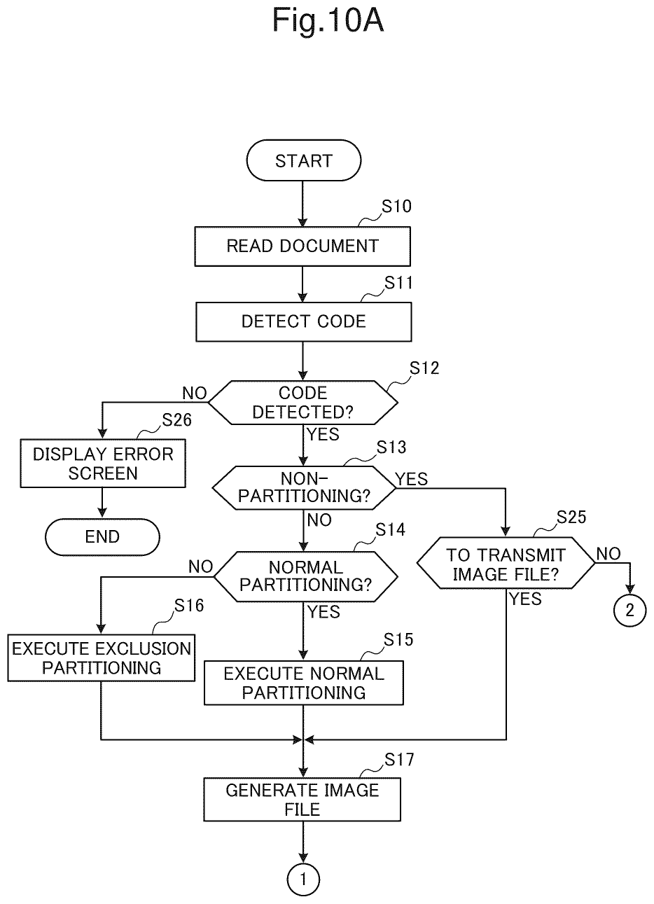

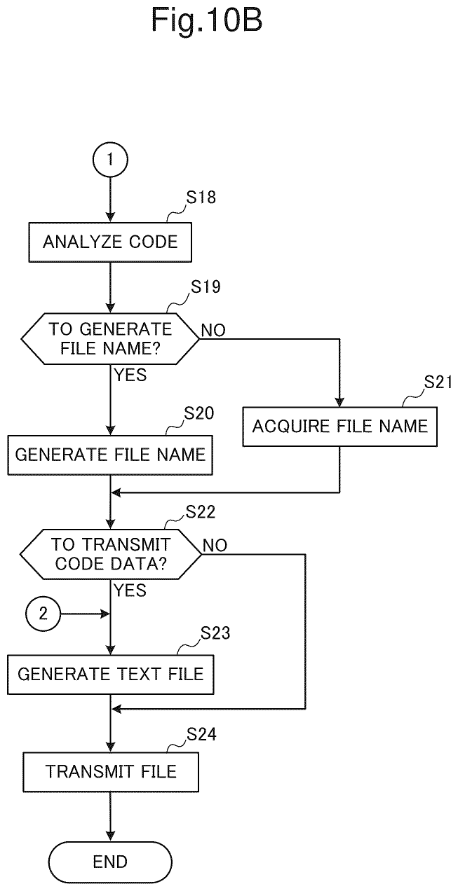

Upon setting the file name as above, the controller 10 starts to execute the file transmission process shown in FIG. 10A and FIG. 10B.

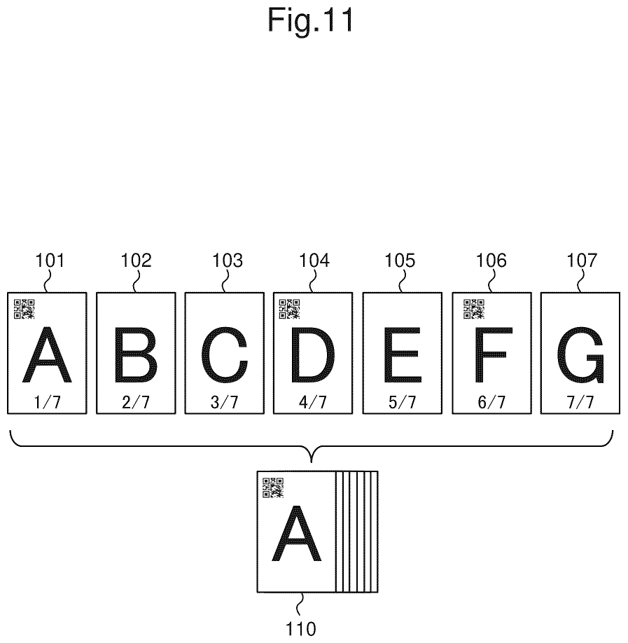

First, the controller 10 causes the image reading device 11 to read each page of a plurality of documents, sequentially delivered by the document feeding device 6 one by one, and generate the image data representing the document image of the plurality of pages (step S10). In this case, the image reading device 11 generates the image data 110, representing the document images 101 to 107 of the first to seventh pages, as shown in FIG. 11.

After step S10, the controller 10 executes a code detection process for detecting a predetermined code, with respect to the image data generated by the image reading device 11 (step S11). It will be assumed here that the controller 10 sets the entirety of the document images as the detection region, and a quick response (QR) code as the type of the code to be detected.

In this case, at step S11 the controller 10 detects the QR code, with respect to the detection region (entirety of the document image) of each of the document images 101 to 107 of the first to seventh pages shown in FIG. 11. After step S11, the controller 10 decides whether the code has been detected through the code detection process (step S12).

### (1) When Code is Detected

In the example of FIG. 11, the QR code is detected from the document image 101 of the first page, the document image 104 of the fourth page, and the document image 106 of the sixth page, and therefore the controller 10 decides that the code has been detected (YES at step S12), and decides whether the non-partitioning instruction has been received, regarding the partitioning mode of the image data (step S13).

### (1-1) When Normal Partitioning is Set

When the normal partitioning is set as the partitioning mode of the image data, the controller 10 decides that the non-partitioning instruction has not been received (NO at step S13), but that the normal partitioning instruction has been received (YES at step S14), and executes the normal partitioning process with respect to the image data generated by the image reading device 11, thereby generating new image data (step S15).

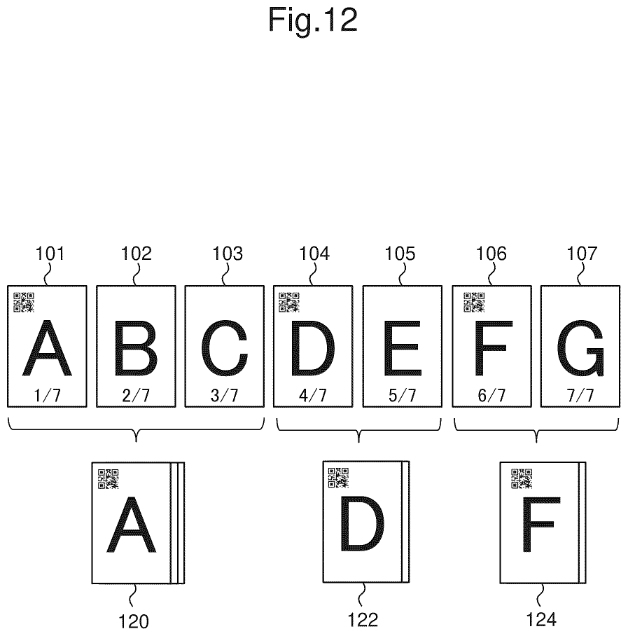

In this case, the controller 10 divides the image data 110 representing the document images 101 to 107 of the first to seventh pages, at the position immediately before the document image 101 of the first page, the document image 104 of the fourth page, and the document image 106 of the sixth page, which each include the QR code, thereby generating new image data 120, 122, and 124, as shown in FIG. 12.

The new image data 120 represents the document images 101 to 103 of the first to third pages. The new image data 122 represents the document images 104 and 105 of the fourth and fifth pages. The new image data 124 represents the document images 106 and 107 of the sixth and seventh pages. Thus, the new image data 120, 122, and 124 each include the document image of the page including the QR code.

### (1-2) When Exclusion Partitioning is Set

When the exclusion partitioning is set as the partitioning mode of the image data, the controller 10 decides that the non-partitioning instruction has not been received (NO at step S13), and also that the normal partitioning instruction has been received either (i.e., exclusion partitioning instruction has been received) (NO at step S14), and executes the exclusion partitioning process with respect to the image data generated by the image reading device 11, thereby generating new image data (step S16).

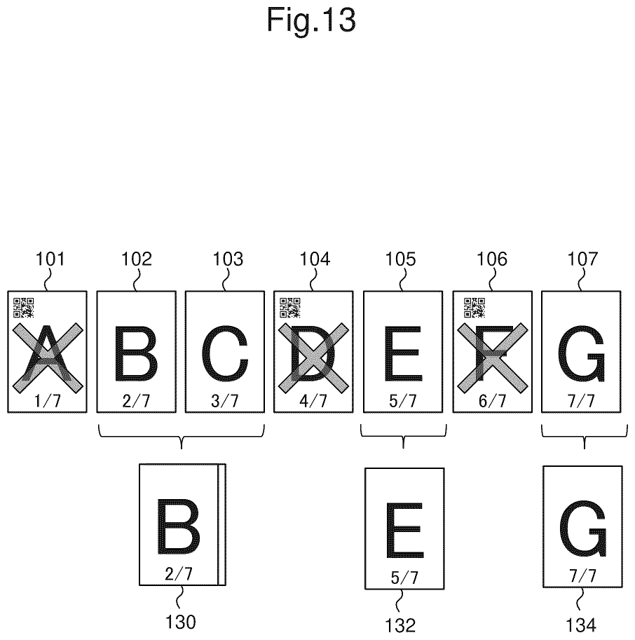

In this case, the controller 10 divides the image data 110 representing the document images 101 to 107 of the first to seventh pages, at the position immediately before the document image 101 of the first page, the document image 104 of the fourth page, and the document image 106 of the sixth page, which each include the QR code, and excludes the document images 101, 104, and 106 including the QR code, thereby generating new image data 130, 132, and 134, as shown in FIG. 13.

The new image data 130 represents the document images 102 and 103 of the second and third pages. The new image data 132 represents the document image 105 of the fifth page. The new image data 134 represents the document image 107 of the seventh page. Thus, the new image data 130, 132, and 134 do not include the document image of the page including the QR code.

After step S15 or step S16, the controller 10 converts the generated new image data to the image file of a predetermined file format (step S17). It will be assumed here that PDF is selected as the file format of the image file. Accordingly, the controller 10 converts the new image data 120, 122, and 124, or the new image data 130, 132, and 134, to the image file of PDF, at step S17.

After step S17, the controller 10 analyzes the code detected from the image data, and acquires the code data contained in the code (step S18). It will be assumed here that the controller 10 has acquired a character string “12” from the QR code detected from the document image 101, a character string “34” from the QR code detected from the document image 104, and character string “56” from the QR code detected from the document image 106, as the code data.

After step S18, the controller 10 decides whether the file name is to be generated (step S19). When the automatic generation is set in relation to the file name, the controller 10 decides that the file name is to be generated (YES at step S19). Then the controller 10 generates the file name using the code data, and assigns the file name to the image file (step S20).

To be more specific, the controller 10 generates the file name, by combining a predetermined character string “New_transaction_” with the character string acquired from the code. In this case, the controller 10 assigns the file name “New_transaction_12” to the image file generated from the image data 120 or 130, the file name “New_transaction_34” to the image file generated from the image data 122 or 132, and the file name “New_transaction_56” to the image file generated from the image data 124 or 134.

In contrast, when the manual input is set in relation to the file name, the controller 10 decides that the file name is not to be generated (NO at step S19). Then the controller 10 acquires a character string inputted via the operation device 16, for example from the RAM, and assigns the acquired character string to the image file, as the file name (step S21).

After step S20 or step S21, the controller 10 decides whether the code data is to be transmitted (step S22). When the transmission of the code data is set to “necessary”, the controller 10 decides that the code data is to be transmitted (YES at step S22), and generates a text file indicating the code data (step S23).

It will be assumed here that the CSV format is set as the file format of the text file. In this case, the controller 10 generates, at step S23, the text file in the CSV format, indicating the character string “12, 34, 56” acquired from the QR code included in each of the document images 101, 104, and 106.

After step 23, the controller 10 transmits the image file and the text file that have been generated, to a shared folder indicated by the destination that has been set, via the communication device 22, using a server message block (SMB) transmission function or a file transfer protocol (FTP) transmission function (step S24).

In contrast, when the transmission of the code data is set to “unnecessary”, the controller 10 decides that the code data is not to be transmitted (NO at step S22), and transmits only the generated image file, to the shared folder indicated by the destination that has been set, using the SMB transmission function or the FTP transmission function (step S24). After step S24, the controller 10 finishes the file transmission process.

### (1-3) When Non-Partitioning is Set

When the non-partitioning is set as the partitioning mode of the image data (YES at step S13), the controller 10 decides whether the image file is to be transmitted (step S25).

When the transmission of the image file is set to “necessary”, the controller 10 decides that the image file is to be transmitted (YES at step S25), and executes the operation of step S17 and the subsequent steps, similarly to the above. When the transmission of the image file is set to “unnecessary”, the controller 10 decides that the image file is not to be transmitted (NO at step S25), and executes the operation of step S23 and the subsequent steps, similarly to the above.

### (2) When Code is Not Detected

When the code is unable to be detected from the image data through the code detection process, for example because of wrong setting of the code to be detected (NO at step S12), the controller 10 causes the display device 15 to display an error screen indicating that the code is unable to be detected (step S26). After step S26, the controller 10 finishes the file transmission process.

Now, when the image data representing the document image of a plurality of pages is to be partitioned, it would be convenient if the image data can be partitioned using the code. The aforementioned first and second techniques make no reference to the partitioning of the image data representing the document image of a plurality of pages. With the aforementioned third technique, the partitioning method has to be stored in advance in the code, and therefore the trouble of making up the code is imposed on the user.

According to the foregoing embodiment, however, when the code is detected through the code detection process, and the normal partitioning instruction is received via the operation device 16, the controller 10 executes the normal partitioning process with respect to the image data. When the code is detected through the code detection process, and the exclusion partitioning instruction is received via the operation device 16, the controller 10 executes the exclusion partitioning process with respect to the image data.

Thus, the image data partitioning is executed using the code, according to the instruction indicating the partitioning mode, received via the operation device 16, and therefore there is no need to store the partitioning mode in the code in advance. As a result, the user is exempted from the trouble of making up the code, which leads to improved convenience to the user.

According to the embodiment, the controller 10 acquires the character string contained in the code, and generates the file name of the image file, using the acquired character string. Accordingly, the user is exempted from the trouble of inputting the file name via the operation device 16, and therefore the convenience to the user can be further improved.

In addition, according to the embodiment, the controller 10 acquires the character string contained in the code, and generates the text file indicating the acquired character string. Such an arrangement facilitates the user to recognize the information contained in all the codes that have been detected, thereby further improving the convenience to the user.

According to the embodiment, further, the controller 10 receives the instruction to define the detection region in the document image, via the operation device 16, and executes the code detection process with respect to the detection region that has been defined, in each of the document images of the plurality of pages. Such an arrangement prevents an unnecessary scanning operation from being performed with respect to the regions that do not include the code, thereby enabling the code detection process to be more efficiently executed.

### First Variation

According to the foregoing embodiment, the controller 10 is configured to cause the display device 15 to display the error screen, when the code is unable to be detected through the code detection process. However, the disclosure is not limited to such an embodiment.

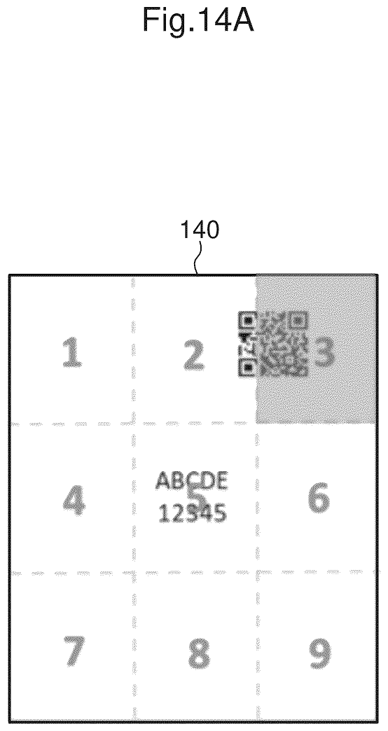

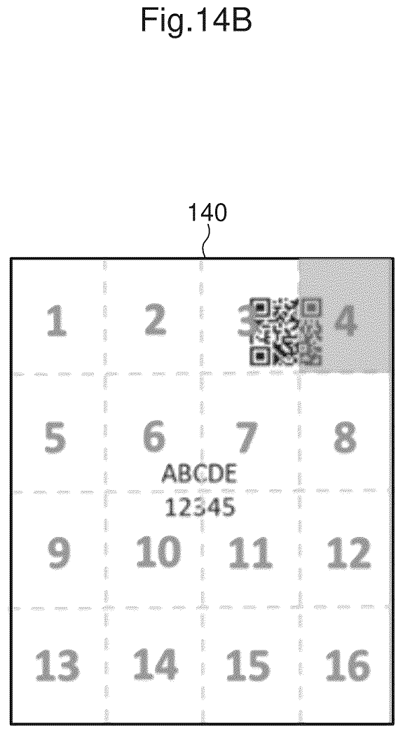

For example, when the division into 9 parts is designated as the size of the detection region, and “3” is designated as the region number, the controller 10 is unable to detect the code through the code detection process, because the code is located so as to stride over the regions corresponding to the region number “2” and “3” in the document image 140, as shown in FIG. 14A.

Likewise, when the division into 16 parts is designated as the size of the detection region, and “4” is designated as the region number, the controller 10 is unable to detect the code through the code detection process, because the code is located so as to stride over the regions corresponding to region number “3” and “4” in the document image 140, as shown in FIG. 14B.

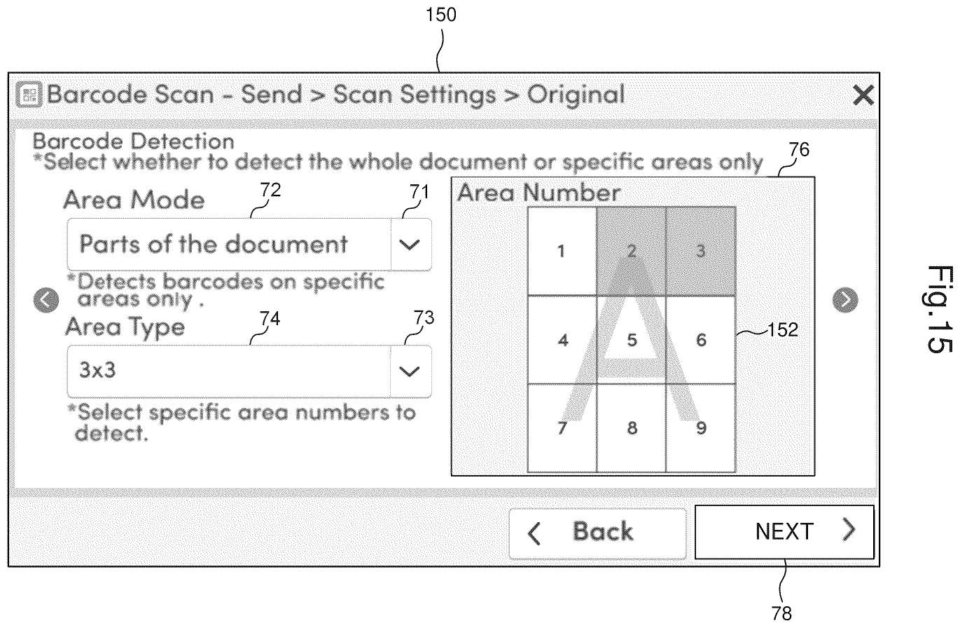

In the case where, as described above, a part of the document image (specifically, information indicating the size of the detection region and the region number) is designated as the detection region, and the code is unable to be detected through the code detection process, the controller 10 causes the display device 15 to display a resetting screen 150 for again designating the detection region, as shown in FIG. 15.

At this time, the controller 10 causes the display device 15, on the basis of the detection region designated until the resetting screen 150 is displayed, to display, for example, the character string “Parts of the document” in the box 72, and the character string “3×3 (3 columns by 3 rows)” in the box 74.

The controller 10 causes the display device 15 to further display a preview image 152, including nine regions numbered from 1 to 9, and arranged in the pattern of 3 columns by 3 rows, from the upper left corner to the lower right corner, in the display region 76.

When the touch panel 16B detects the touch operation of the user on the regions in the image 152, to which the region numbers “2” and “3” are assigned, the controller 10 causes the display device 15 to display the touched regions in a different color from the remaining regions.

When the touch panel 16B detects the touch operation of the user on the key 78 under such a situation, the controller 10 receives the instruction to redesignate the detection region, and redesignates the selected region (specifically, information indicating the size of the detection region and the region number) as the detection region. Then the controller 10 executes the code detection process, with respect to the redesignated detection region in each of the plurality of document images.

The arrangement according to the first variation enables the user to redesignate the detection region, in view of the preview image 152, thereby facilitating the user to accurately designate the detection region through the redesignating process, despite having designated a wrong detection region at first. Therefore, the convenience to the user can be further improved.

### Other Variations

According to the foregoing embodiment, the controller 10 is configured to transmit at least one of the image file and the text file, to the designated destination. However, the disclosure is not limited to such an embodiment. For example, when the touch panel 16B detects the touch operation of the user on the key 34 in the job selection screen 30, the controller 10 receives the instruction to select the job to be saved. In this case, the controller 10 saves at least one of the image file and the text file, in a universal serial bus (USB) memory connected to a USB port provided in the image forming apparatus 1.

The disclosure may be modified in various manners, without limitation to the foregoing embodiments. For example, although the image forming apparatus 1 is exemplified by the color multifunction peripheral in the embodiments, the disclosure is also applicable to other types of image forming apparatus, such as a monochrome multifunction peripheral, a copier, or a facsimile machine.

Further, the configurations and processings described in the embodiments with reference to FIG. 1 to FIG. 15 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image reading apparatus comprising:
an image reading device that reads each page of a plurality of documents, and generates image data representing a document image of a plurality of pages;
an operation device to which an instruction of a user is inputted; and
a controller including a processor, and configured to execute a code detection process for detecting a predetermined code, with respect to the image data, when the processor executes a control program,
the controller being configured to:
execute, when the code is detected through the code detection process, and a normal partitioning instruction is received via the operation device, a normal partitioning process including partitioning the image data at a position corresponding to a page containing the code, the document image of the page containing the code inclusive;
execute, when the code is detected through the code detection process, and an exclusion partitioning instruction is received via the operation device, an exclusion partitioning process including partitioning the image data at the position corresponding to the page containing the code, excluding the document image of the page containing the code; and
convert new image data generated through the normal partitioning process or the exclusion partitioning process, to an image file of a predetermined format.

2. The image reading apparatus according to claim 1,
wherein the controller acquires a character string contained in the code, and generates a file name of the image file using the character string.

3. The image reading apparatus according to claim 1,
wherein the controller acquires a character string contained in the code, and generates a text file representing the character string.

4. The image reading apparatus according to claim 1,
wherein the controller receives, via the operation device, an instruction to designate a detection region in the document image, and executes the code detection process with respect to the detection region in each of the document images of the plurality of pages.

5. The image reading apparatus according to claim 4, further comprising a display device,
wherein, when the code is not detected through the code detection process, the controller causes the display device to display a resetting screen for redesignating the detection region, receives an instruction to redesignate the detection region in the document image, via the operation device, and executes the code detection process with respect to the detection region redesignated, in each of the plurality of document images.

6. The image reading apparatus according to claim 1, further comprising a display device,
wherein the controller causes the display device to display a screen showing types of a plurality of codes, and
when the operation device receives an input of an instruction to select one of the types of the plurality of codes, the controller designates the selected type of the code, as the type of a code to be detected.
